(19) United States
(12) Patent Application Publication
(10) Pub. No.: US 2013/0143006 A1
(43) Pub. Date: Jun. 6, 2013

(54) Reducing Porosity in Composite Structures

(71) Applicant: Kathy Lynn Ferguson, Woodinville, WA (US)

(72) Inventor: Kathy Lynn Ferguson, Woodinville, WA (US)

(73) Assignee: THE BOEING COMPANY, Chicago, IL (US)

(21) Appl. No.: 13/309,964

(22) Filed: Dec. 2, 2011

(51) Int. Cl. B32B 3/26; B32B 37/14

(52) U.S. Cl. 428/189; 156/87; 428/311.11; 428/311.51; 428/316.6

(57) ABSTRACT

A method and apparatus for reducing porosity in a composite structure. A first layer of composite material may be applied over a surface. A venting layer may be applied over the first layer of composite material. A second layer of composite material may be applied over the venting layer. The first layer of composite material, the venting layer, and the second layer of composite material may form a composite layup for the composite structure.

### BACKGROUND INFORMATION

1. Field:

The present disclosure relates generally to composite structures and, in particular, to reducing porosity in composite structures.

2. Background:

Composite structures may be comprised of layers of composite material. A composite material may be made from two or more different types of materials with different physical and/or chemical properties which may remain separate and distinct within the composite material. Further, when used to form a composite structure, these different physical and/or chemical properties may also remain separate and distinct within the composite structure. Examples of composite materials may include, for example, without limitation, fiber-reinforced polymers, carbon-fiber reinforced plastic, glass-reinforced plastic, a metal composite material, a ceramic composite material, a cermet, a hybrid composite material, and shape memory polymers.

The strength of a composite structure may be based on a number of different factors. These factors may include, for example, without limitation, porosity of the composite structure. The porosity of a structure may be a measure of the void spaces in the structure. In particular, porosity may be represented as a fraction of the volume of void spaces in a structure over a total volume of the structure. The void spaces in a structure may be the empty spaces in the structure. Typically, these empty spaces may be filled with air and/or other types of gases and/or fluids. Void spaces also may be referred to as voids.

When the porosity of a composite structure is outside of selected tolerances, the strength of the composite structure may be less than desirable. In particular, the strength between the different layers of composite material in the composite structure may be less than desirable when the porosity of the composite structure is outside of selected tolerances.

Currently, composite structures formed using pre-impregnated materials may have reduced porosity as compared to composite structures formed using wet layup materials. A pre-impregnated material, also referred to as a prepreg material, may be a material pre-infused with resin. A wet layup process may include applying liquid resin to a dry reinforcement material as the dry reinforcement material is laid up.

Currently available methods for forming composite structures using prepreg materials may result in composite structures with desired porosity. Some wet layup processes may result in a cured composite structure with a higher than desired porosity and/or number of voids.

However, storage and handling of prepreg materials may be more difficult and expensive when compared to wet layup materials. For example, a prepreg material may have a relatively short shelf life. Further, prepreg materials may need to be stored in facilities capable of storage at temperatures below room temperature. Stored prepreg materials may need to be monitored over time to monitor the shelf and working lives of these prepreg materials and/or may require additional maintenance.

Materials used in wet layup processes may have relatively long shelf lives when compared to prepreg materials, because the resin and the dry reinforcement material may be stored separately. Further, wet layup materials may be stored at room temperature for relatively long periods of time. Additionally, wet layup materials may be less expensive than prepreg materials.

Therefore, it would be desirable to have a method and apparatus that takes into account at least some of the issues discussed above, as well as possibly other issues.

### SUMMARY

In one illustrative embodiment, a method may be provided for reducing porosity in a composite structure. A first layer of composite material may be applied over a surface. A venting layer may be applied over the first layer of composite material. A second layer of composite material may be applied over the venting layer. The first layer of composite material, the venting layer, and the second layer of composite material may form a composite layup for the composite structure.

In another illustrative embodiment, a method may be provided for forming a composite patch. A first layer of composite material may be applied over a surface. A first venting layer may be applied over the first layer of composite material. A second layer of composite material may be applied over the first venting layer. A second venting layer may be applied over the second layer of composite material. The first venting layer and the second venting layer may be selected from one of a positioning fabric, Buckypaper, a fiberglass layer, and a nanomaterial layer. A third layer of composite material may be applied over the second venting layer. The first layer of composite material, the first venting layer, the second layer of composite material, the second venting layer, and the third layer of composite material may form a composite layup for the composite patch. Each of the first layer of composite material, the second layer of composite material, and the third layer of composite material may comprise a number of plies and may be selected from at least one of a wet layup layer and a prepreg layer. The composite layup may be cured to form the composite patch. A number of fluids may escape through a number of pathways, formed by the first venting layer and the second venting layer, during curing of the composite layup such that the porosity in the composite patch may be reduced and in which the number of fluids may include at least one of air, moisture, a chemical, and a volatile gas.

In yet another illustrative embodiment, an apparatus may comprise a plurality of layers of composite material and a number of venting layers laid up between the plurality of layers of composite material. The number of venting layers and the plurality of layers of composite material may form a composite layup. The number of venting layers may be configured to provide a number of pathways for allowing a number of fluids to escape out of the composite layup during curing of the composite layup.

In still yet another illustrative embodiment, a composite patch may comprise a first layer of composite material applied over a surface, a first venting layer applied over the first layer of composite material, a second layer of composite material applied over the first venting layer, a second venting layer applied over the second layer of composite material, and a third layer of composite material applied over the second venting layer. The first venting layer and the second venting layer may be selected from one of a positioning fabric, Buckypaper, a fiberglass layer, and a nanomaterial layer. Each of the first layer of composite material, the second layer of composite material, and the third layer of composite material may comprise a number of plies and may be selected from one of a wet layup layer and a prepreg layer. The first layer of composite material, the first venting layer, the second layer of composite material, the second venting layer, and the third layer of composite material may form the composite layup configured to be cured to form the composite patch. The first venting layer and the second venting layer may be configured to provide a number of pathways for allowing a number of fluids to escape out of the composite layup during curing of the composite layup such that porosity of the composite patch may be reduced. The number of fluids may include at least one of air, moisture, a chemical, and a volatile gas.

The features and functions may be achieved independently in various embodiments of the present disclosure or may be combined in yet other embodiments in which further details may be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives, and features thereof will best be understood by reference to the following detailed description of an illustrative embodiment of the present disclosure when read in conjunction with the accompanying drawings, wherein:

FIG. 1 is an illustration of a block diagram of a manufacturing environment in accordance with an illustrative embodiment;

FIG. 2 is an illustration of a composite layup in accordance with an illustrative embodiment;

FIG. 3 is an illustration of a cross-sectional view of a curing system for curing a composite layup in accordance with an illustrative embodiment;

FIGS. 4-16 are illustrations of a process for forming a composite layup for a composite structure as part of an assembly in a curing system in accordance with an illustrative embodiment;

FIG. 17 is an illustration of a fiberglass layer applied over a layer of composite material in accordance with an illustrative embodiment;

FIG. 18 is an illustration of a composite layup used in a rework of a part in accordance with an illustrative embodiment;

FIG. 19 is an illustration of a flowchart of a process for reducing porosity in a composite structure in accordance with an illustrative embodiment;

FIG. 20 is an illustration of an aircraft manufacturing and service method in accordance with an illustrative embodiment; and

FIG. 21 is an illustration of an aircraft in which an illustrative embodiment may be implemented.

### DETAILED DESCRIPTION

The different illustrative embodiments recognize and take into account different considerations. For example, without limitation, the different illustrative embodiments recognize and take into account that prepreg materials may be used to form a composite structure with a desired level of porosity such that the number of voids formed in the composite structure are within selected tolerances. A prepreg material may be a fabric of nonwoven material or roving combined with resin. In other words, a prepreg material may be a fabric pre-infused with resin, a prepreg tape, a prepreg tow, a unidirectional prepreg, or some other suitable type of prepreg material.

The different illustrative embodiments also recognize and take into account that materials for use in wet layup processes may have a longer shelf life as compared to prepreg materials. A wet layup fabric may be an example of a composite layup formed using the wet layup process. The different illustrative embodiments recognize and take into account that both the resin materials and dry reinforcement materials used in wet layup processes may be stored longer than prepreg materials. Further, the resin materials used in wet layup processes may not require refrigeration for storage as compared to prepreg materials.

For these reasons, using wet layup materials may be preferable to prepreg materials. For example, without limitation, using wet layup materials may reduce the cost of forming composite structures. However, the different illustrative embodiments recognize and take into account that in some cases, composite structures formed using wet layup materials may have increased porosity as compared to composite structures formed using prepreg materials.

Additionally, the different illustrative embodiments recognize and take into account that porosity may be increased when wet layup materials and prepreg materials are used for manufacturing parts that have curved surfaces and/or performing reworks in areas that have curved surfaces and/or recessed areas. Further, the different illustrative embodiments recognize and take into account that the amount of air and moisture vented during curing of wet layup materials or prepreg materials may depend on the geometry of the part being manufactured using the wet layup or prepreg.

The different illustrative embodiments also recognize and take into account that some currently available methods for reducing porosity in composite structures formed using wet layup materials may be more time-consuming and expensive than desired. Further, some currently available methods for reducing porosity in composite structures may be limited in the number of plies that may be used to form a composite structure.

Thus, the different illustrative embodiments may provide a method and apparatus for reducing porosity in a composite structure. In one illustrative embodiment, a method for reducing porosity in a composite structure may be provided. A venting layer may be applied over a first layer of composite material. A second layer of composite material may be applied over the venting layer. The first layer of composite material, the venting layer, and the second layer of composite material may form a composite layup for the composite structure.

The composite layup may be cured to form the composite structure. The venting layer may provide a number of pathways for allowing a number of fluids to escape out of the composite layup during curing of the composite layup.

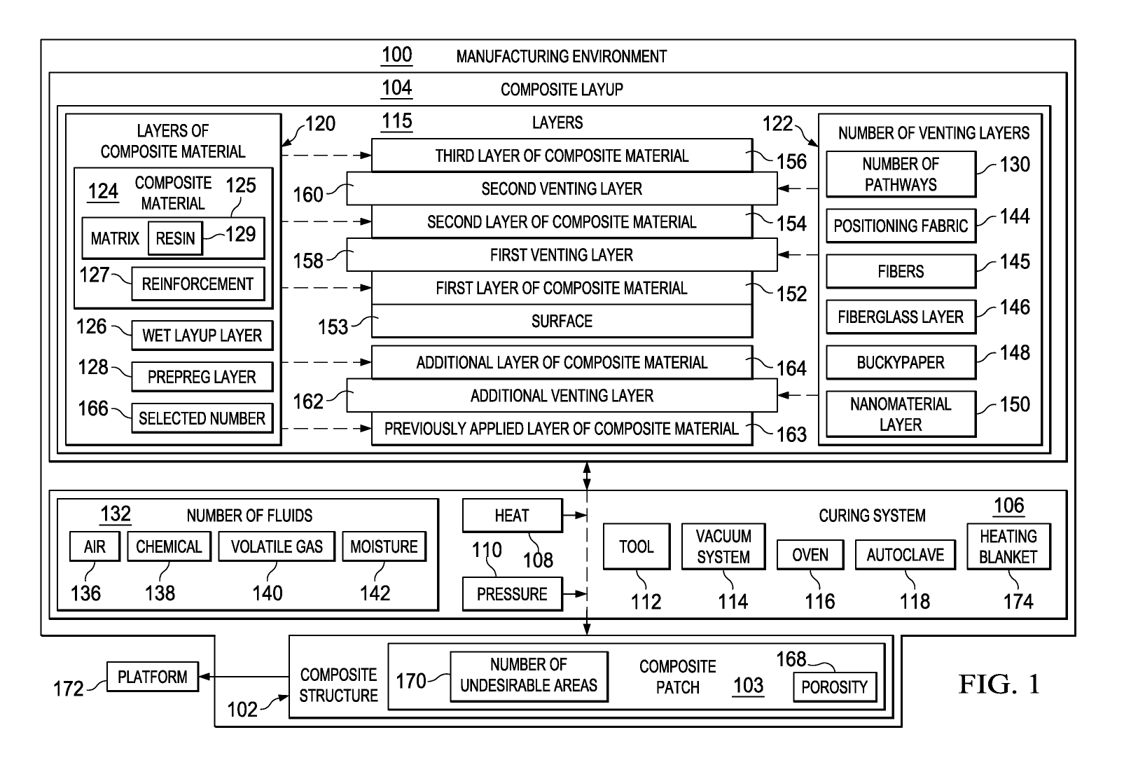

With reference now to FIG. 1, an illustration of a block diagram of a manufacturing environment is depicted in accordance with an illustrative embodiment. In these illustrative examples, manufacturing environment 100 may be an environment in which composite structure 102 may be formed. Composite structure 102 may be formed by curing composite layup 104 using curing system 106.

Curing system 106 may be configured to apply at least one of heat 108 and pressure 110 to composite layup 104 to cure composite layup 104. In these illustrative examples, curing system 106 may comprise at least one of tool 112, vacuum system 114, oven 116, autoclave 118, and other suitable devices that may be used to apply at least one of heat 108 and pressure 110 to composite layup 104. Depending on the implementation, tool 112 may take the form of a caul plate, a mandrel, a mold, a metal plate, or some other suitable type of tool.

As used herein, the phrase “at least one of”, when used with a list of items, means different combinations of one or more of the listed items may be used and only one of each item in the list may be needed. For example, “at least one of item A, item B, and item C” may include, for example, without limitation, item A, or item A and item B. This example also may include item A, item B, and item C, or item B and item C.

In other examples, “at least one of” may be, for example, without limitation, two of item A, one of item B, and ten of item C; four of item B and seven of item C; and other suitable combinations.

Composite layup 104 may be comprised of layers 115. In these illustrative examples, layers 115 may include layers of composite material 120 and number of venting layers 122. Of course, depending on the implementation, other layers may be included in composite layup 104.

A layer in layers of composite material 120 may take the form of any type of layer containing composite material 124. Composite material 124 may include at least one of matrix 125 and reinforcement 127.

Matrix 125 may be a substantially uniform material in which reinforcement 127 may be embedded. As one illustrative example, matrix 125 may take the form of resin 129. Resin 129 may be any polymer material that may be used to support reinforcement 127. Resin 129 may take the form of, for example, without limitation, epoxy, polyamide, a polyester, a polyimide, or some other suitable type of resin.

Reinforcement 127 may comprise, for example, without limitation, fibers that form a fabric, tape, foil, a screen, ground minerals, and other suitable types of materials that may be supported using matrix 125. Reinforcement 127 may comprise, for example, without limitation, at least one of carbon fibers, fiberglass fibers, aramid fibers, metallic fibers, metal layers, ceramic fibers, and other suitable types of reinforcement materials.

In these illustrative examples, matrix 125 and reinforcement 127 may be combined to form composite material 124. For example, without limitation, composite material 124 may be formed by infusing or impregnating reinforcement 127 with resin 129.

Each layer of composite material in layers of composite material 120 may comprise any number of plies. As used herein, a “ply” may be a single layer of composite material. For example, without limitation, a layer of composite material in layers of composite material 120 may include one, two, three, four, five, or some other number of plies.

Further, in one illustrative example, each layer in layers of composite material 120 may take the form of wet layup layer 126. In another illustrative example, each layer in layers of composite material 120 may take the form of prepreg layer 128. Of course, in other illustrative examples, layers of composite material 120 may include other suitable types of layers containing composite material 124.

Wet layup layer 126 may be any number of plies in which each ply is formed by liquid resin being applied to dry reinforcement material. Prepreg layer 128 may be any number of plies in which each ply is formed by a reinforcement material pre-infused with resin.

In these illustrative examples, a venting layer in number of venting layers 122 may take the form of any layer that is configured to provide number of pathways 130 for allowing number of fluids 132 to escape composite layup 104 during curing. In other words, a venting layer in number of venting layers 122 may take the form of any layer that is configured to provide number of pathways 130 for allowing number of fluids 132 to vent out of composite layup 104 during curing.

As used herein, a “fluid” may comprise at least one of a liquid, air, and a gas. For example, without limitation, number of fluids 132 may include at least one of air 136, chemical 138 produced by resin 129 during curing, volatile gas 140 produced by resin 129 during curing, moisture 142, and other suitable types of liquids and gases.

In these illustrative examples, a venting layer in number of venting layers 122 may be formed by fibers 145 that are arranged in the form of, for example, without limitation, a woven fabric, a woven mat, a veil, a knit configuration, a web configuration, or some other suitable type of configuration. Fibers 145 may extend past layers of composite material 120 in a manner that forms number of pathways 130 that allow number of fluids 132 to escape during curing of composite layup 104.

Number of venting layers 122 may include, for example, without limitation, at least one of positioning fabric 144, fiberglass layer 146, Buckypaper 148, nanomaterial layer 150, and other suitable types of venting layers. Other suitable types of venting layers may include, for example, without limitation, a nylon layer, a polyester fiber layer, and other suitable types layers that may allow number of fluids 132 to be vented out of composite layup 104.

Positioning fabric 144 may also be referred to as a positioning cloth or a scrim cloth. In one illustrative example, different types of positioning fabric 144 may be obtained from Aerospheres (UK) Limited (Ltd).

When a venting layer in number of venting layers 122 takes the form of positioning fabric 144, the fibers that form positioning fabric 144 may form number of pathways 130. For example, without limitation, number of fluids 132 may be allowed to escape by traveling along and/or within the different fibers in positioning fabric 144.

As another example, fiberglass layer 146 may take the form of a plurality of fiberglass strands that may be arranged to form a single layer. Number of pathways 130 may be formed along the different fiberglass strands in fiberglass layer 146.

Further, Buckypaper 148 may be a thin sheet comprising an arrangement of carbon nanotubes. Nanomaterial layer 150 may take the form of a plurality of nanowires, nanotubes, nanofibers, and/or other suitable types of nanosized elements that may be arranged to form a single layer. Of course, in other illustrative examples, other types of venting layers may be used in composite layup 104.

Composite layup 104 may be formed in a number of different ways having a number of different configurations for layers of composite material 120 and number of venting layers 122. In one illustrative example, layers of composite material 120 in composite layup 104 may include first layer of composite material 152, second layer of composite material 154, and third layer of composite material 156. Further, number of venting layers 122 may include first venting layer 158 and second venting layer 160.

In this illustrative example, composite layup 104 may be formed by first applying first layer of composite material 152 over surface 153. Surface 153 may be, for example, a surface of tool 112. Of course, in other illustrative examples, surface 153 may be selected from one of, for example, without limitation, a wing, a fuselage, a support structure, a skin panel, a spacecraft, or some other suitable type of surface.

First venting layer 158 may then be applied over first layer of composite material 152. Next, second layer of composite material 154 may be applied over first venting layer 158. Second venting layer 160 may then be applied over second layer of composite material 154. Thereafter, third layer of composite material 156 may be applied over second venting layer 160.

In this manner, first layer of composite material 152, first venting layer 158, second layer of composite material 154, second venting layer 160, and third layer of composite material 156 may form composite layup 104 for composite structure 102. First layer of composite material 152 and third layer of composite material 156 may form the bottom layer and top layer, respectively, of composite layup 104.

Further, in other illustrative examples, layers of composite material 120 may include additional layers of composite material, and number of venting layers 122 may include additional venting layers. For example, without limitation, additional venting layer 162 may be applied over previously applied layer of composite material 163 in layers of composite material 120. In one illustrative example, previously applied layer of composite material 163 may be third layer of composite material 156. Of course, in other illustrative examples, previously applied layer of composite material 163 may be some other layer of composite material in layers of composite material 120.

Further, additional layer of composite material 164 may be applied over additional venting layer 162. This process of applying additional venting layer 162 over previously applied layer of composite material 163 and applying additional layer of composite material 164 over additional venting layer 162 may be repeated until selected number 166 of layers of composite material 120 have been laid up to form composite layup 104.

Additionally, in some illustrative examples, more than one layer of composite material in layers of composite material 120 may be applied between venting layers in number of venting layers 122. In other illustrative examples, more than one venting layer in number of venting layers 122 may be applied between layers of composite material in layers of composite material 120. In this manner, layers of composite material 120 and number of venting layers 122 may be stacked up in a number of different ways.

Once composite layup 104 has been formed, composite layup 104 may then be cured using curing system 106 to form composite structure 102. During curing of composite layup 104, number of venting layers 122 in composite layup 104 may be configured to allow number of fluids 132 to escape out of composite layup 104 through number of pathways 130.

In this manner, porosity 168 of composite structure 102 formed using composite layup 104 having number of venting layers 122 may be reduced as compared to composite structure 102 formed using composite layup 104 not having number of venting layers 122. Porosity 168 of composite structure 102 may be a measure of number of undesirable areas 170 in composite structure 102.

Number of undesirable areas 170 may include any number of voids within composite structure 102. As used herein, a “void” may be a space within composite structure 102 not filled with material from layers 115 in composite layup 104. For example, without limitation, a void may be a space or pocket in composite structure 102 filled with one or more of number of fluids 132. In this illustrative example, porosity 168 may be reduced when number of undesirable areas 170 in composite structure 102 is reduced.

In this manner, the different illustrative embodiments may provide a process for forming composite layup 104 in a manner that reduces porosity 168 in composite structure 102 formed using composite layup 104. Reducing porosity 168 in composite structure 102 may improve strength and durability of composite structure 102.

For example, without limitation, composite structure 102 may be configured for use in platform 172. Reducing porosity 168 in composite structure 102 may improve the strength and durability of composite structure 102 used in platform 172.

Platform 172 may take a number of different forms. For example, without limitation, platform 172 may be selected from one of a mobile platform, an aquatic-based structure, a space-based structure, an aircraft, an unmanned aerial vehicle, a surface ship, a tank, a personnel carrier, a train, a spacecraft, a space station, a satellite, a submarine, an automobile, or some other suitable type of stationary or mobile platform.

Further, in some cases, composite structure 102 may be configured for use in reworking a part or portion of platform 172. In these cases, when composite structure 102 is used for reworking a part or portion of platform 172, composite structure 102 may be referred to as composite patch 103.

For example, without limitation, composite layup 104 may be laid up at a location of an inconsistency outside of selected tolerances on platform 172. An inconsistency outside of selected tolerances may be an undesired inconsistency.

In some illustrative examples, composite layup 104 may be laid up at the location of the inconsistency and then cured as part of the rework. In these examples, surface 153 over which first layer of composite material 152 is applied may be a surface of the part or portion of platform 172 being reworked. For example, without limitation, surface 153 may be a skin panel for an aircraft.

In other illustrative examples, composite layup 104 may be laid up at the location of the inconsistency and then cured at this location to form composite patch 103. Of course, in some cases, composite layup 104 may be first partially cured to form a partially cured composite layup prior to being placed at the location of the inconsistency. This partially cured composite layup may be placed at the location of the inconsistency and then fully cured as part of the rework of the inconsistency.

In still other cases, composite layup 104 may be pre-cured to form composite patch 103. Composite patch 103 may then be applied to the rework location or stored for use at a later point in time. In other words, composite patch 103 may be stored in a number of remote locations until composite patch 103 is needed for reworking an inconsistency.

Pre-curing composite layup 104 may include, for example, without limitation, at least partially hardening resin 129 in composite layup 104 using heat. In some cases, pre-curing composite layup 104 may include fully hardening resin 129 in composite layup 104.

In one illustrative example, when platform 172 takes the form of an aircraft, the inconsistency outside of selected tolerances may be an inconsistency at a bond line for the aircraft. Composite layup 104 may be laid up at this rework location and then cured at this rework location to form composite patch 103 at the bond line.

Composite patch 103 may be formed such that the inconsistency is no longer present at the bond line. Further, using number of venting layers 122 in composite layup 104 may ensure that number of desirable areas 170 are reduced and/or prevented from forming in composite patch 103 during curing of composite layup 104 to form composite patch 103. In other words, using number of venting layers 122 in composite layup 104 may reduce porosity 168 of composite patch 103.

The illustration of manufacturing environment 100 in FIG. 1 is not meant to imply physical or architectural limitations to the manner in which an illustrative embodiment may be implemented. Other components in addition to and/or in place of the ones illustrated may be used. Some components may be optional. Also, the blocks are presented to illustrate some functional components. One or more of these blocks may be combined, divided, or combined and divided into different blocks when implemented in an illustrative embodiment.

In some illustrative examples, layers in addition to layers of composite material 120 and number of venting layers 122 may be present in layers 115 of composite layup 104. In other illustrative examples, curing system 106 may include other devices in addition to and/or in place of the ones described above. For example, without limitation, curing system 106 may include heating blanket 174.

Further, in still other illustrative examples, a layer of composite material in layers of composite material 120 may not form the top layer and/or bottom layer of composite layup 104. For example, without limitation, in some cases, a venting layer in number of venting layers 122 may form the top layer or bottom layer of composite layup 104. In still other illustrative examples, an adhesive layer may form the top layer and/or bottom layer of composite layup 104.

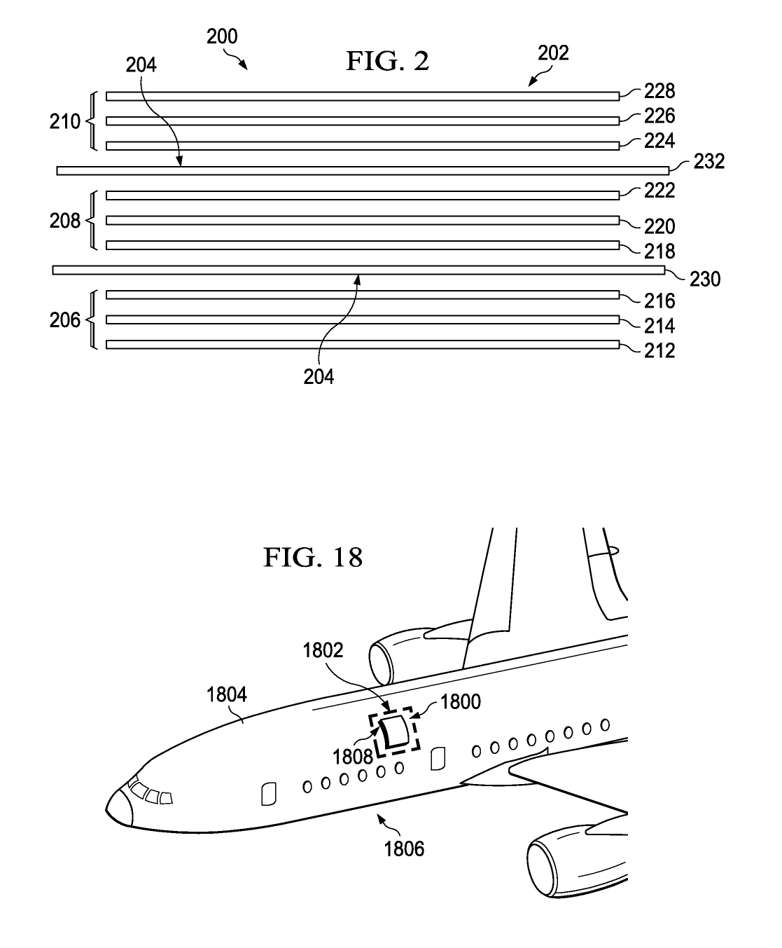

With reference now to FIG. 2, an illustration of a composite layup is depicted in accordance with an illustrative embodiment. The different components shown in FIG. 2 may be combined with components in FIG. 1, used with components in FIG. 1, or a combination of the two. Additionally, some of the components in this figure may be illustrative examples of how components shown in block form in FIG. 1 may be implemented as physical structures.

In this illustrative example, composite layup 200 may be an example of one implementation for composite layup 104 in FIG. 1. As depicted, composite layup 200 may include layers of composite material 202 and venting layers 204.

Layers of composite material 202 may include first layer of composite material 206, second layer of composite material 208, and third layer of composite material 210. As illustrated, each of these layers of composite material may comprise three plies. For example, without limitation, first layer of composite material 206 may include first ply 212, second ply 214, and third ply 216. Second layer of composite material 208 may include first ply 218, second ply 220, and third ply 222. Third layer of composite material 210 may include first ply 224, second ply 226, and third ply 228. In this illustrative example, first ply 212, second ply 214, third ply 216, first ply 218, second ply 220, third ply 222, first ply 224, second ply 226, and third ply 228 may take the form of carbon-reinforced plies.

Venting layers 204 may include first venting layer 230 and second venting layer 232. First venting layer 230 and second venting layer 232 may take the form of positioning fabrics in this illustrative example.

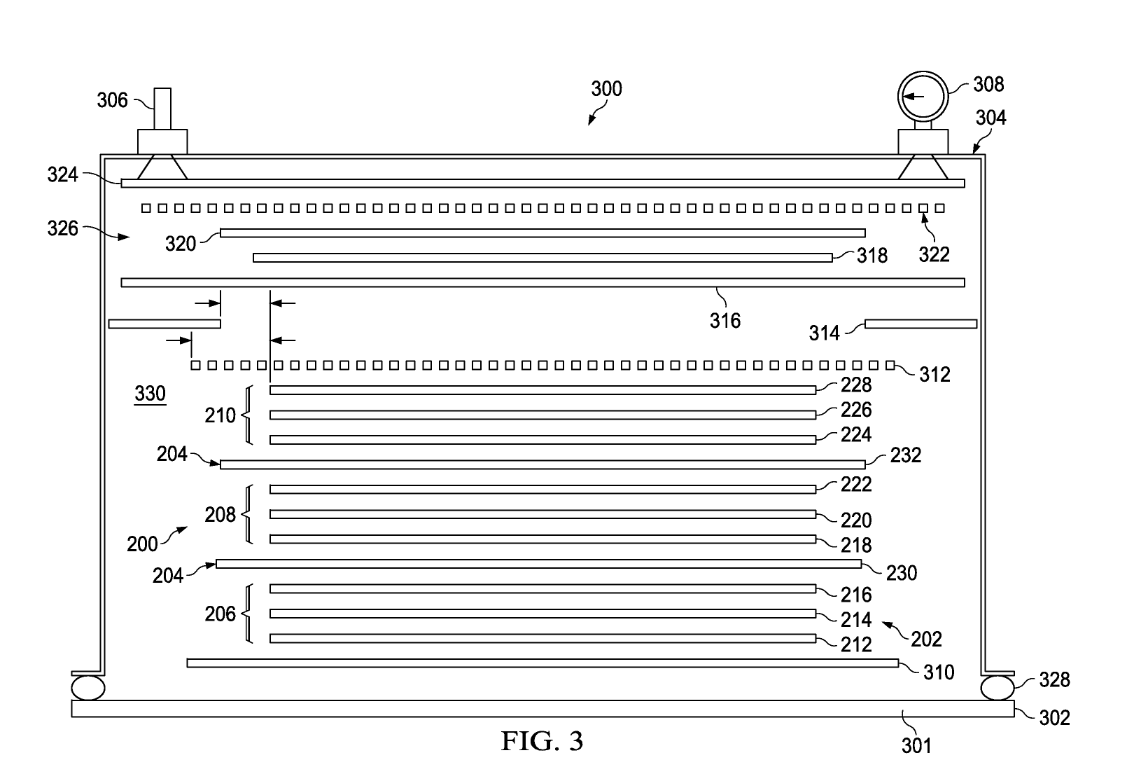

With reference now to FIG. 3, an illustration of a cross-sectional view of a curing system for curing a composite layup is depicted in accordance with an illustrative embodiment. The different components shown in FIG. 3 may be combined with components in FIG. 1, used with components in FIG. 1, or a combination of the two. Additionally, some of the components in FIG. 3 may be illustrative examples of how components shown in block form in FIG. 1 may be implemented as physical structures.

As depicted in this example, curing system 300 may be used to cure composite layup 200 from FIG. 2. In this illustrative example, curing system 300 may include tool 301, vacuum bagging 304, vacuum probe 306, and vacuum gauge 308. As depicted, release film 310 may be applied over tool 301.

In this depicted example, tool 301 may take the form of caul plate 302. However, in other illustrative examples, tool 301 may take the form of a metal plate, a mandrel, a mold, a part, a structure, a metal structure, or some other suitable type of tool over which materials may be laid up.

Caul plate 302 may be a metal sheet or cured plastic sheet that is used to provide a smooth surface for the composite structure formed by curing composite layup 200. Release film 310 may be a film comprised of any material configured to be easily removed from caul plate 302 after curing. Release film 310 may take the form of a liquid or solid film, depending on the implementation.

Composite layup 200 from FIG. 2 may then be applied over release film 310. In particular, the different layers of composite layup 200 from FIG. 2 may be laid up over release film 310 to form composite layup 200. However, in some illustrative examples, composite layup 200 may be formed prior to composite layup 200 being applied over release film 310.

Perforated release film 312 may then be applied over composite layup 200. Edge breather material 314 may be applied over perforated release film 312 around the edges of composite layup 200. Edge breather material 314 may be a porous material that provides a substantially continuous air path over and/or around composite layup 200.

Further, as illustrated, fiberglass fabric 316 may be applied over edge breather material 314 and over perforated release film 312. Fiberglass fabric 316 may be porous and may help in venting composite layup 200. Release film 318 may be applied over fiberglass fabric 316. Heat blanket 320 may be applied over release film 318.

Additionally, perforated release film 322 may then be applied over heat blanket 320. Breather material 324 may be applied over perforated release film 322. In this manner, release film 310, composite layup 200, perforated release film 312, edge breather material 314, fiberglass fabric 316, release film 318, heat blanket 320, perforated release film 322, and breather material 324 may form assembly 326.

Vacuum bagging 304 may be placed over assembly 326. Sealing tape 328 may be used to seal vacuum bagging 304 to caul plate 302 and provide enclosed space 330 around assembly 326.

In this illustrative example, vacuum probe 306 may be configured to reduce a pressure inside enclosed space 330 to apply a vacuum to enclosed space 330. Vacuum gauge 308 may be used to measure the pressure inside enclosed space 330. Further, heat blanket 320 may be configured to apply heat to assembly 326.

This application of a vacuum and heat may cause composite layup 200 to be cured to form a composite structure. Further, venting layers 204 in composite layup 200 may provide pathways (not shown) for fluids (not shown) to escape out of composite layup 200. These fluids (not shown) may include, for example, without limitation, air, moisture, chemicals produced during curing, volatile gases produced during curing, and other types of fluids.

The illustrations of composite layup 200 in FIG. 2 and curing system 300 in FIG. 3 are not meant to imply physical or architectural limitations to the manner in which an illustrative embodiment may be implemented. Other components in addition to or in place of the ones illustrated may be used. Some components may be optional.

For example, without limitation, other layers may be present in composite layup 200 in addition to or in place of the ones described above. Further, in other illustrative examples, one or more of perforated release film 312, release film 318, and perforated release film 322 may be excluded from assembly 326.

Still further, although composite layup 200 is depicted laid up over caul plate 302 in FIG. 3 having a substantially planar surface, composite layup 200 from FIG. 2 may be laid up over a nonplanar surface. For example, without limitation, in some cases, composite layup 200 may be laid up over a curved surface or a surface having raised and/or recessed portions.

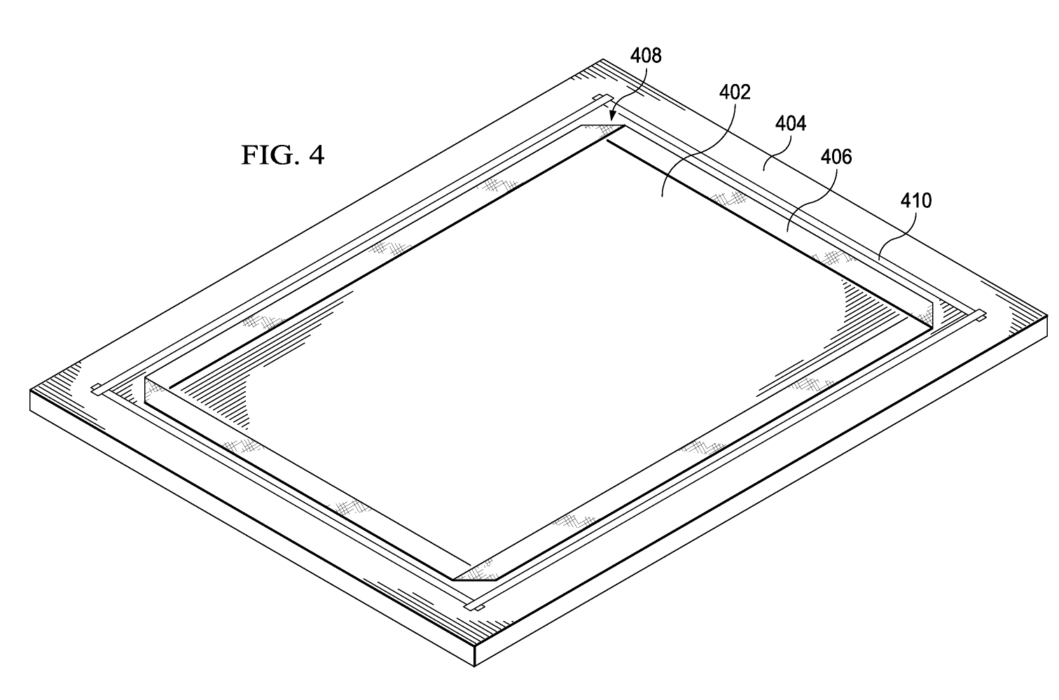

With reference now to FIGS. 4-16, illustrations of a process for forming a composite layup for a composite structure as part of an assembly in a curing system are depicted in accordance with an illustrative embodiment. The process described in FIGS. 4-16 may be an example of one implementation for forming a composite layup, such as composite layup 104 in FIG. 1, or as part of an assembly for a curing system, such as curing system 106 in FIG. 1.

The different components shown in FIGS. 4-16 may be combined with components in FIG. 1, used with components in FIG. 1, or a combination of the two. Additionally, some of the components in these figures may be illustrative examples of how components shown in block form in FIG. 1 may be implemented as physical structures.

In FIG. 4, release film 402 may be applied over caul plate 404. As depicted, edge breather material 406 may be applied around edges 408 of release film 402. Further, sealing tape 410 may be applied over caul plate 404 and around edge breather material 406.

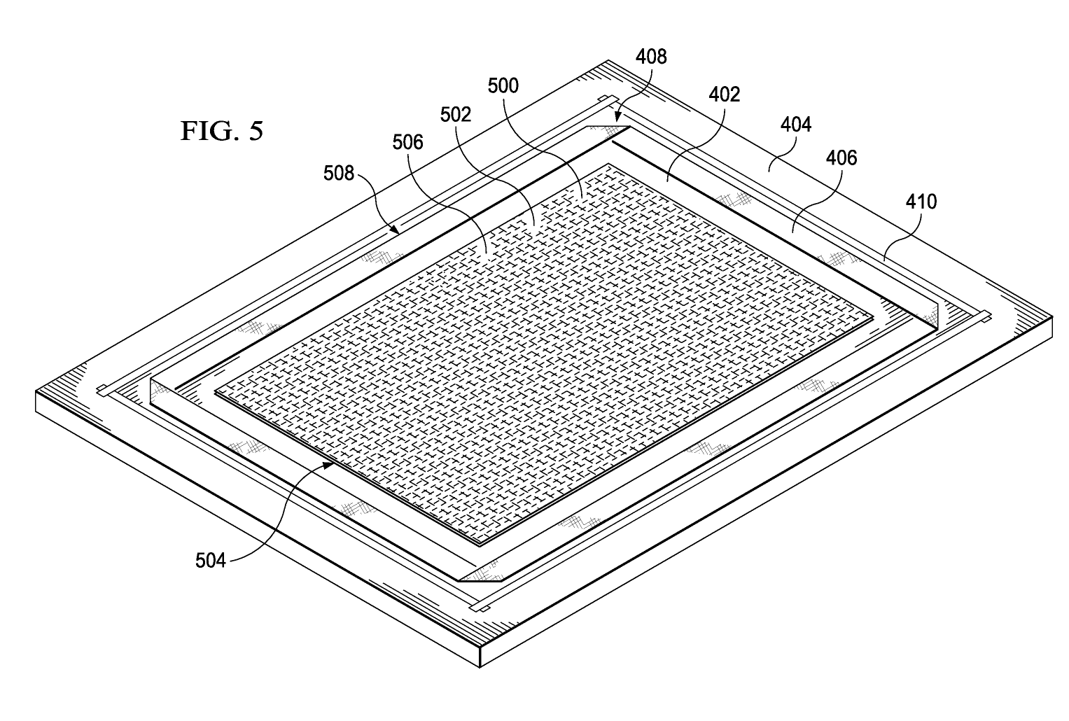

In FIG. 5, first layer of composite material 500 may be applied over release film 402. In this illustrative example, first layer of composite material 500 may take the form of wet layup layer 502. Wet layup layer 502 may comprise number of carbon-reinforced plies 504. As depicted, first layer of composite material 500 may be bottom layer 506 for composite layup 508 being formed.

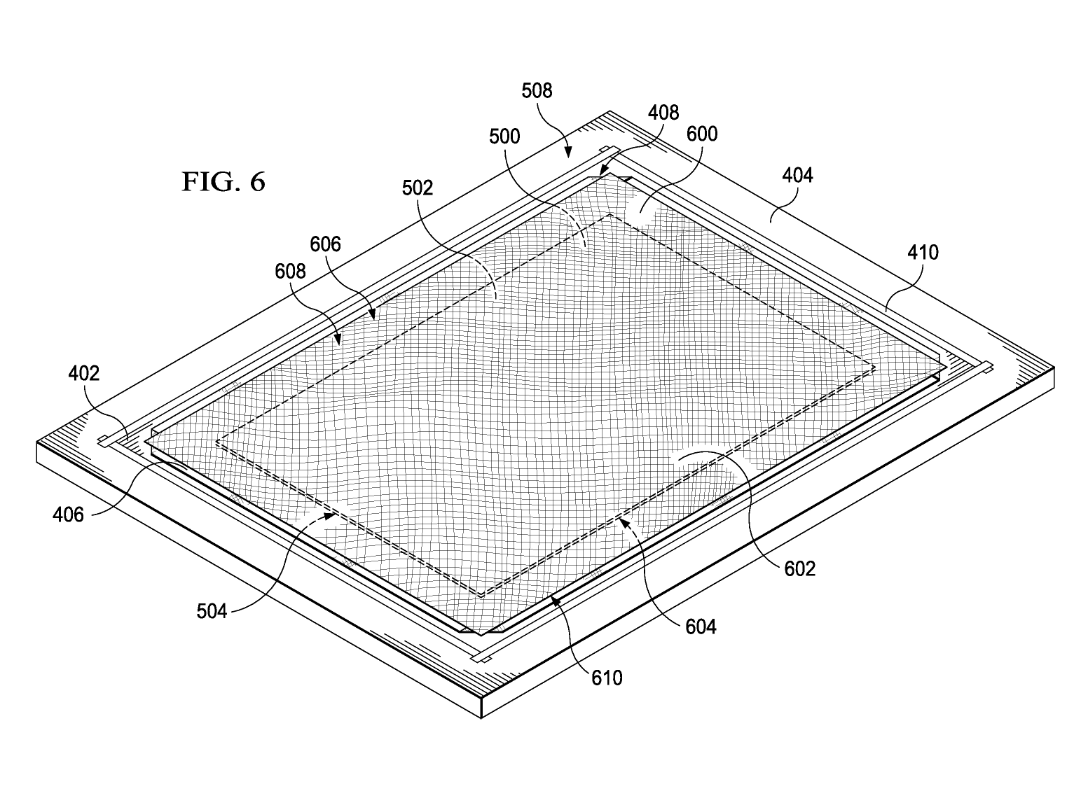

Turning now to FIG. 6, first venting layer 600 may be applied over first layer of composite material 500. First venting layer 600 may take the form of positioning fabric 602 in this illustrative example. As depicted, positioning fabric 602 may be applied over first layer of composite material 500 such that edges 610 of positioning fabric 602 may extend past first edges 604 of first layer of composite material 500.

Positioning fabric 602 may comprise fibers 606 that provide pathways 608 along which fluids (not shown) may be vented out of composite layup 508 during curing. Each pathway in pathways 608 may extend from one of edges 610 of positioning fabric 602 to another edge of edges 610 of positioning fabric 602 to allow fluids (not shown) to vent out of composite layup 508 during curing. In particular, fluids (not shown), such as gases, within composite layup 508 may flow along fibers 606 out of composite layup 508.

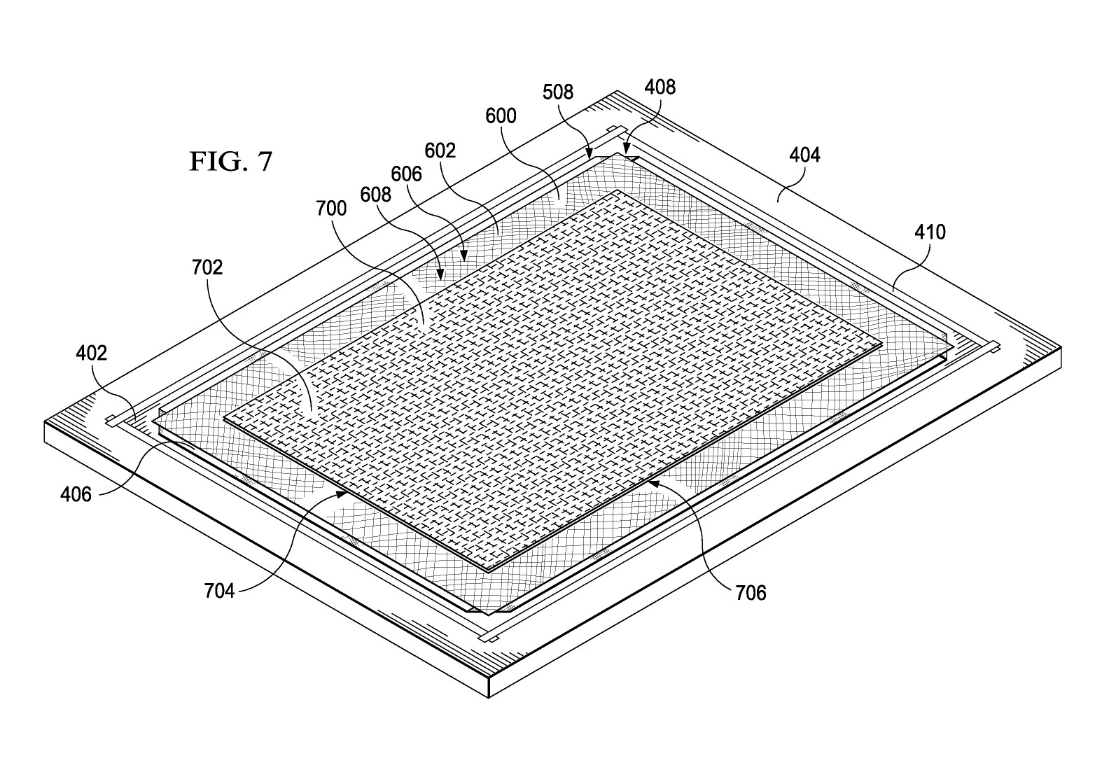

In FIG. 7, second layer of composite material 700 may be applied over first venting layer 600. Second layer of composite material 700 may take the form of wet layup layer 702. Wet layup layer 702 may comprise number of carbon-reinforced plies 704, which may be similar to wet layup layer 502 in FIG. 5. As depicted, first venting layer 600 may extend past both first edges 604 of first layer of composite material 500 and second edges 706 of second layer of composite material 700.

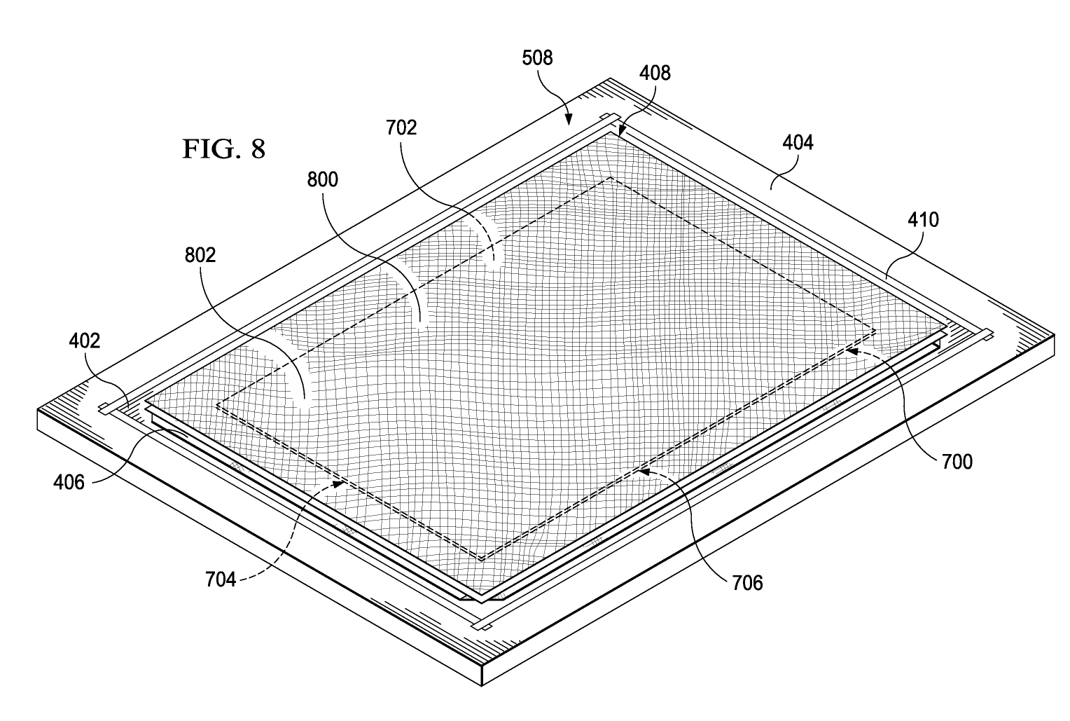

Referring now to FIG. 8, second venting layer 800 may be applied over second layer of composite material 700. Second venting layer 800 may take the form of positioning fabric 802 in this depicted example. Positioning fabric 802 may be similar to positioning fabric 602 in FIG. 6. As depicted, positioning fabric 802 may extend over second edges 706 of second layer of composite material 700.

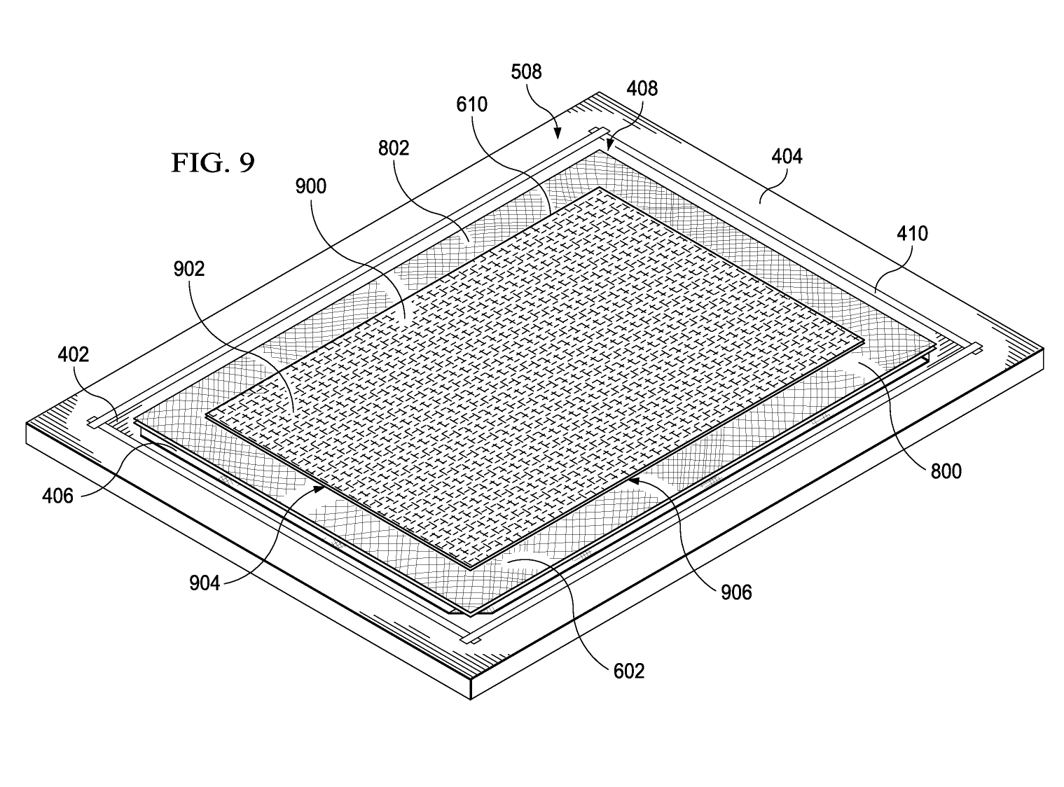

In FIG. 9, third layer of composite material 900 may be applied over second venting layer 800. Third layer of composite material 900 may take the form of wet layup layer 902. Wet layup layer 902 may comprise number of carbon-reinforced plies 904, which may be similar to wet layup layer 502 in FIG. 5 and wet layup layer 702 in FIG. 7. As depicted, positioning fabric 802 may extend over both second edges 706 of second layer of composite material 700 in FIG. 7 and third edges 906 of third layer of composite material 900.

First layer of composite material 500, first venting layer 600, second layer of composite material 700, second venting layer 800, and third layer of composite material 900 may form composite layup 508. Composite layup 508 may be cured to form a composite structure, such as composite structure 102 in FIG. 1.

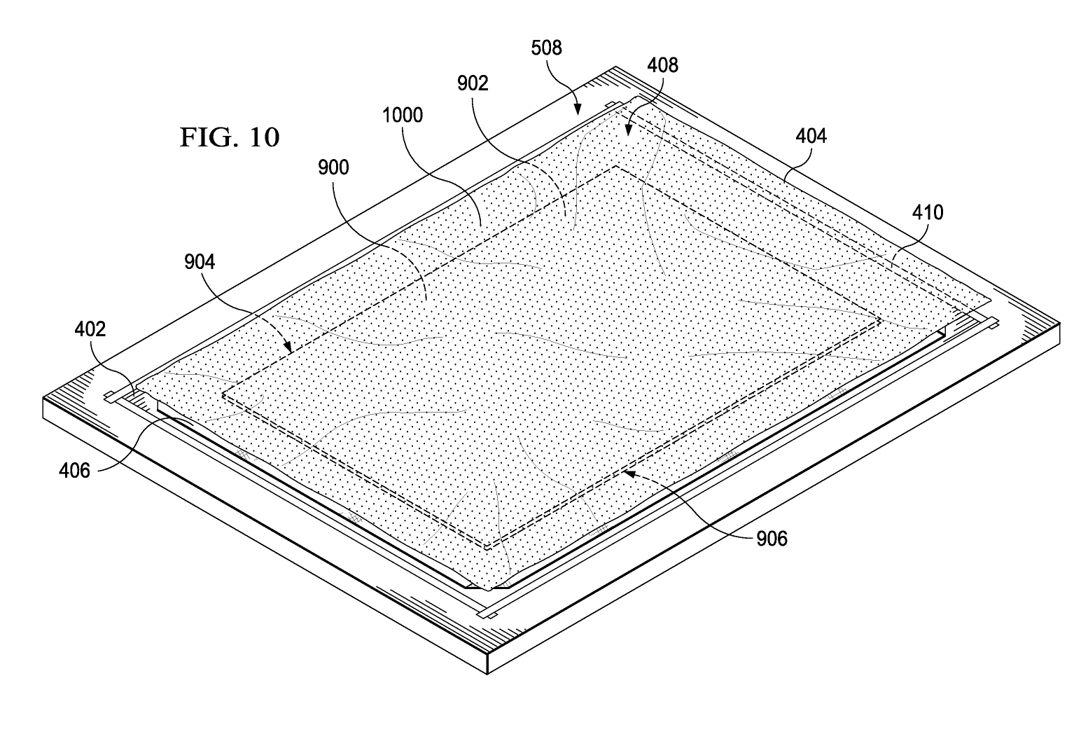

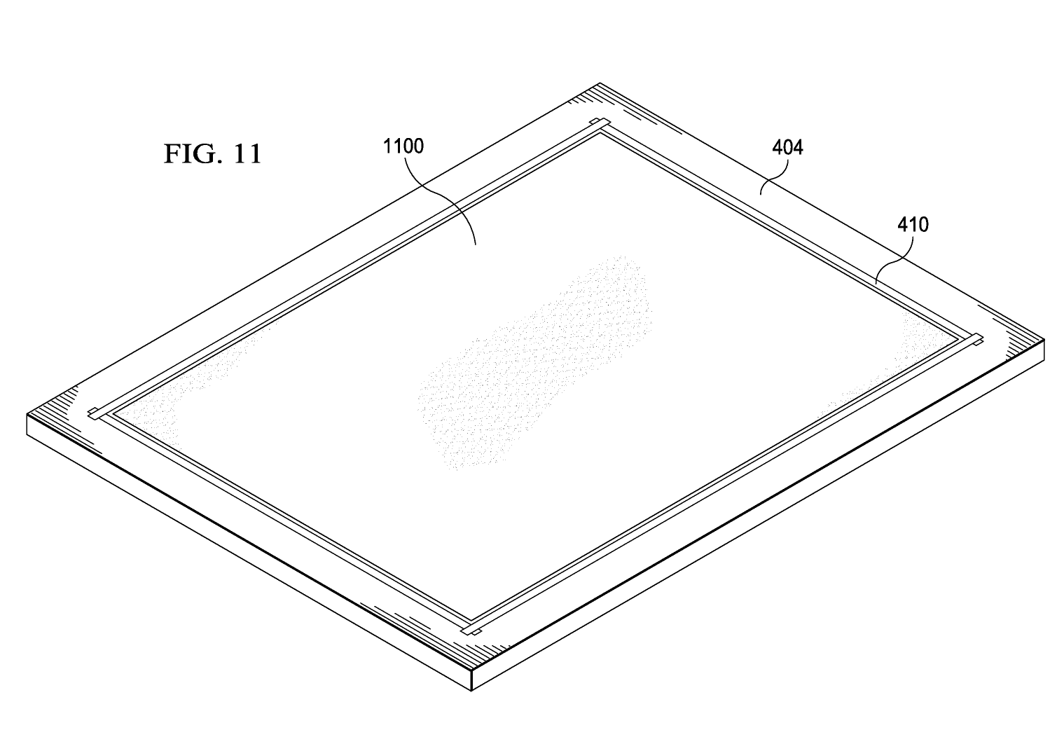

Turning now to FIG. 10, perforated release film 1000 may be applied over composite layup 508. In FIG. 11, fiberglass fabric 1100 may be applied over perforated release film 1000 in FIG. 10. Further, in FIG. 12, release film 1200 may be applied over fiberglass fabric 1100 from FIG. 11.

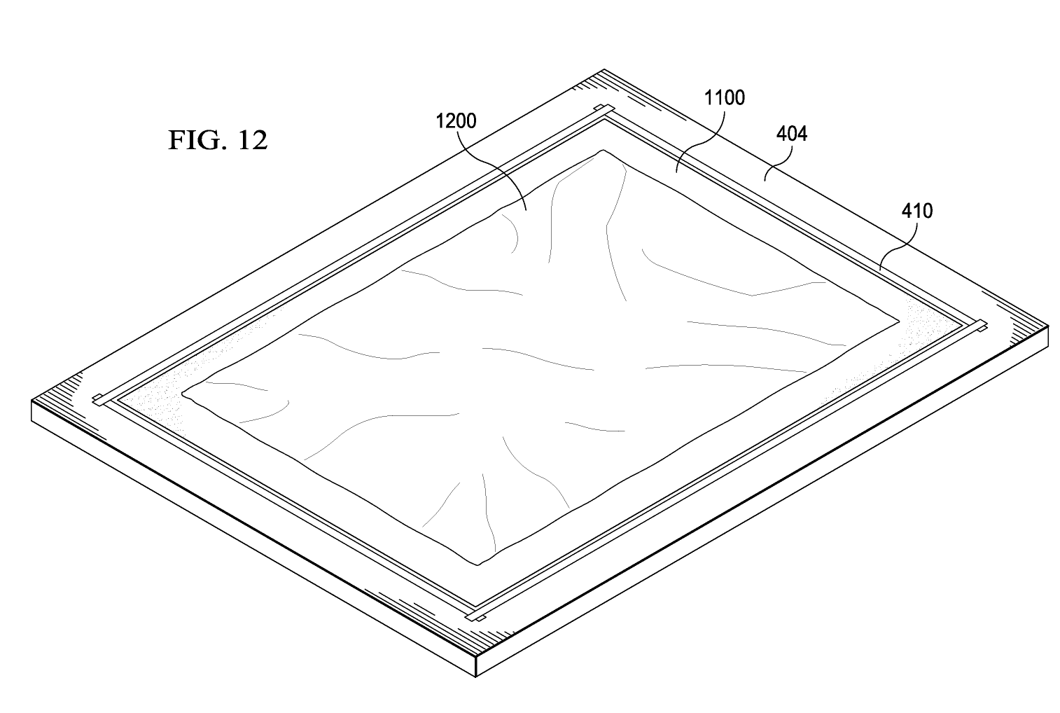

Referring now to FIG. 13, heat blanket 1300 may be applied over release film 1200 in FIG. 12. Heat blanket 1300 may be configured to apply heat to composite layup 508 from FIG. 9 when power is supplied to heat blanket 1300.

Further, thermocouple 1302 and thermocouple 1304 may be placed around the edges of composite layup 508 (not shown), which may be under perforated release film 1000 from FIG. 10, fiberglass fabric 1100 from FIG. 11, and release film 1200 from FIG. 12. Thermocouple 1304 and thermocouple 1302 may be configured to measure the temperature of composite layup 508 when composite layup 508 is heated by heat blanket 1300.

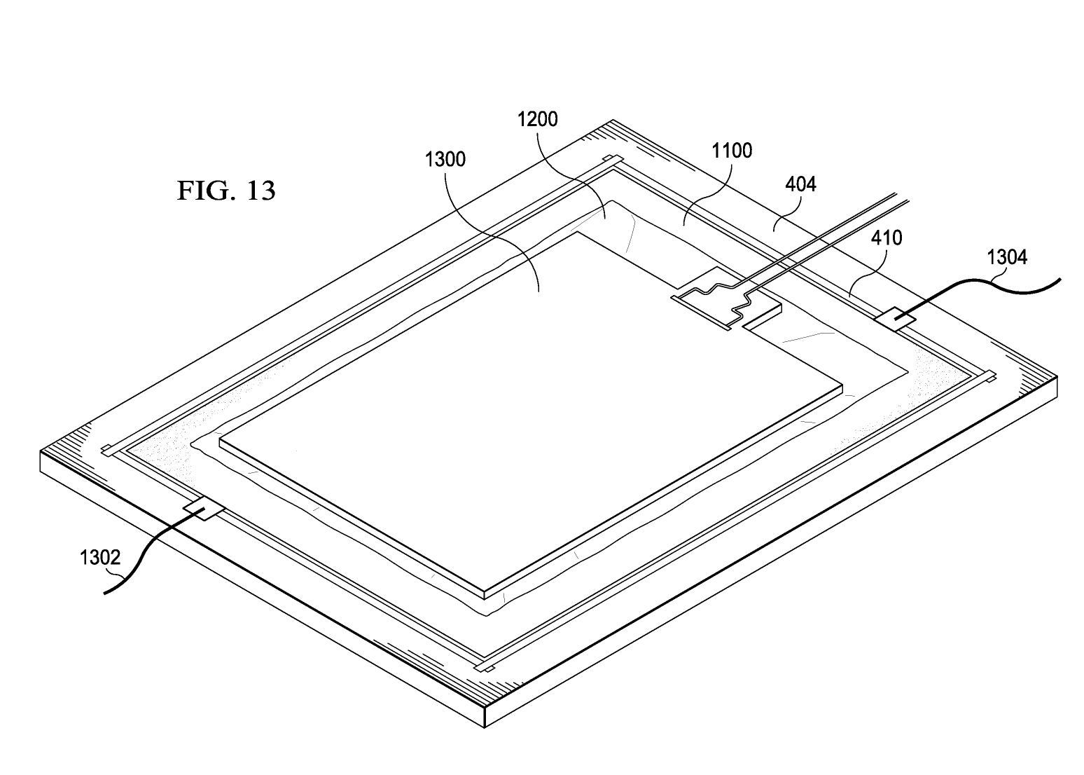

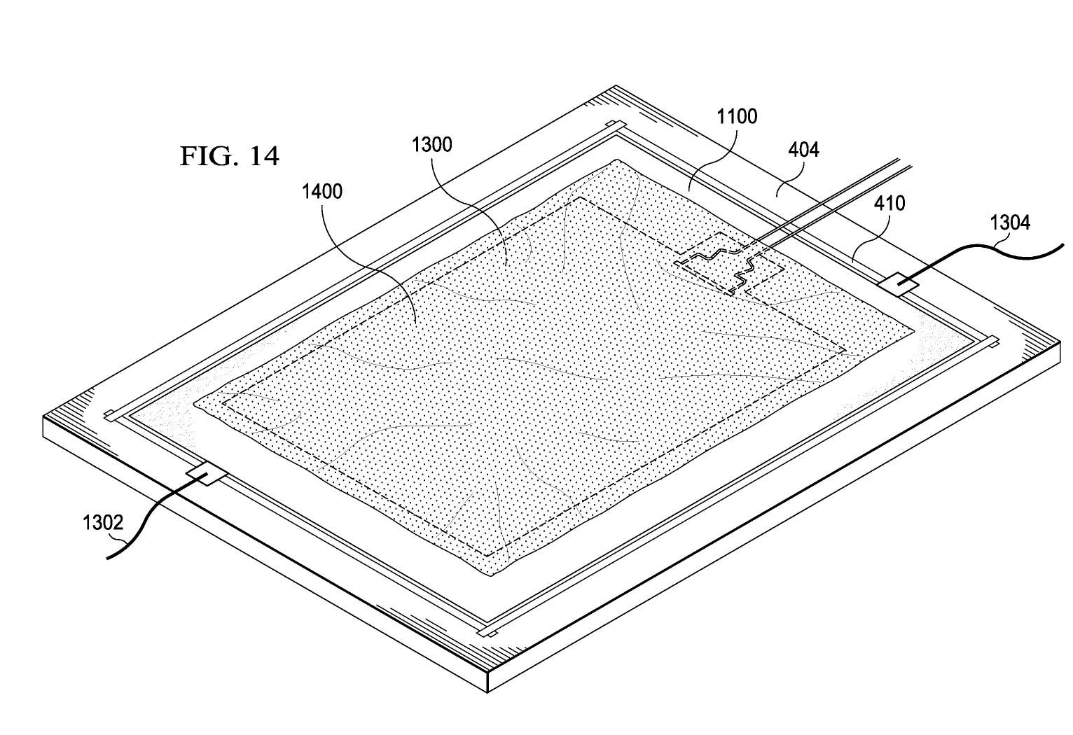

In FIG. 14, perforated release film 1400 may be applied over heat blanket 1300 from FIG. 13. In FIG. 15, breather material 1500 may be applied over perforated release film 1400 from FIG. 14.

In these illustrative examples, caul plate 404 from FIG. 4, release film 402 from FIG. 4, edge breather material 406 from FIG. 4, the fully formed composite layup 508 from FIG. 9, perforated release film 1000 from FIG. 10, fiberglass fabric 1100 from FIG. 11, release film 1200 from FIG. 12, heat blanket 1300 from FIG. 13, perforated release film 1400 from FIG. 14, and breather material 1500 from FIG. 15 may form assembly 1502. In this manner, composite layup 508 may be formed as part of assembly 1502 in these illustrative examples.

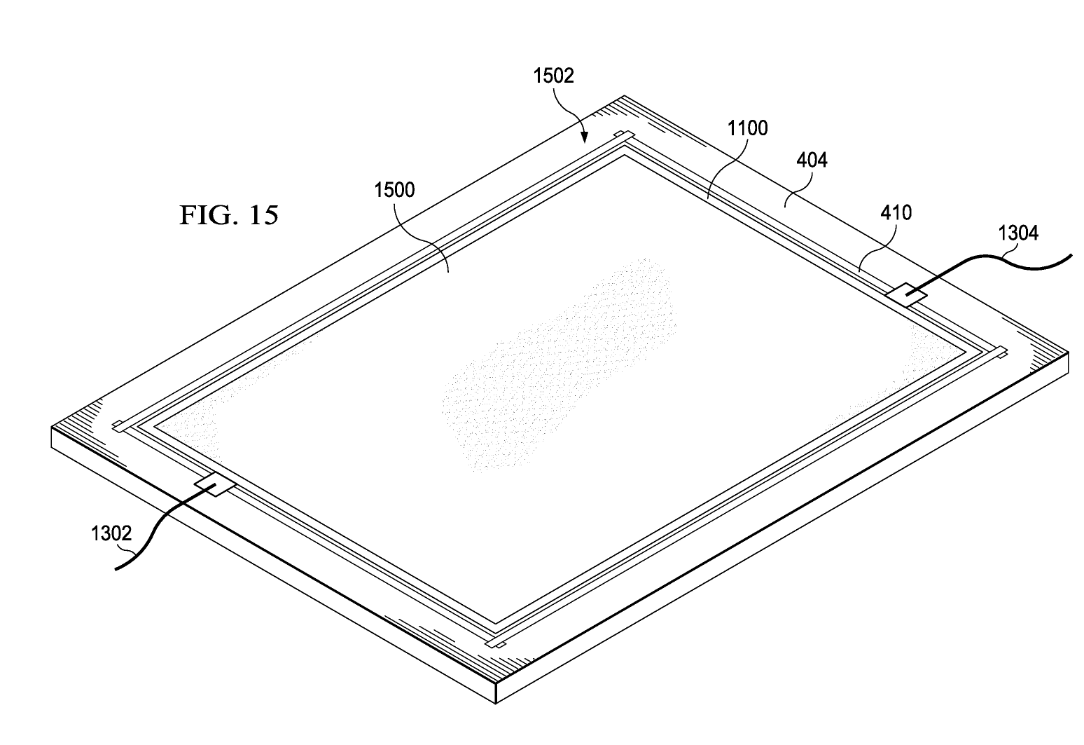

Turning now to FIG. 16, vacuum bagging 1600 may be placed around assembly 1502 from FIG. 15. Sealing tape 410 from FIG. 4 may be used to seal vacuum bagging 1600 such that assembly 1502 is within an enclosed space. Vacuum gauge 1602 and vacuum port 1604 may be connected to vacuum bagging 1600. Vacuum hose 1606 may be connected to vacuum port 1604. Vacuum port 1604 and vacuum hose 1606 may be configured to apply a vacuum within vacuum bagging 1600.

Further, as depicted in this example, controller 1610 may be connected to thermocouple 1302 and thermocouple 1304 from FIG. 13, vacuum gauge 1602, and vacuum hose 1606. Controller 1610 may control the level of heat applied by heat blanket 1300 from FIG. 13. Controller 1610 may also control the pressure applied within vacuum bagging 1600 by vacuum port 1604 and vacuum hose 1606.

First venting layer 600 from FIG. 6 and second venting layer 800 from FIG. 8 may be configured to provide pathways (not shown) that may allow a number of fluids (not shown) to escape out of composite layup 508 during curing. In this manner, the process described in FIGS. 4-16 may be used to cure composite layup 508 in FIG. 9 to form a composite structure, such as composite structure 102 in FIG. 1, with reduced porosity. This composite structure may be used in a platform, such as platform 172 in FIG. 1.

The process illustrated in FIGS. 4-16 is not meant to imply physical or architectural limitations to the manner in which an illustrative embodiment may be implemented. Other components in addition to and/or in place of the ones illustrated may be used. Some components may be optional.

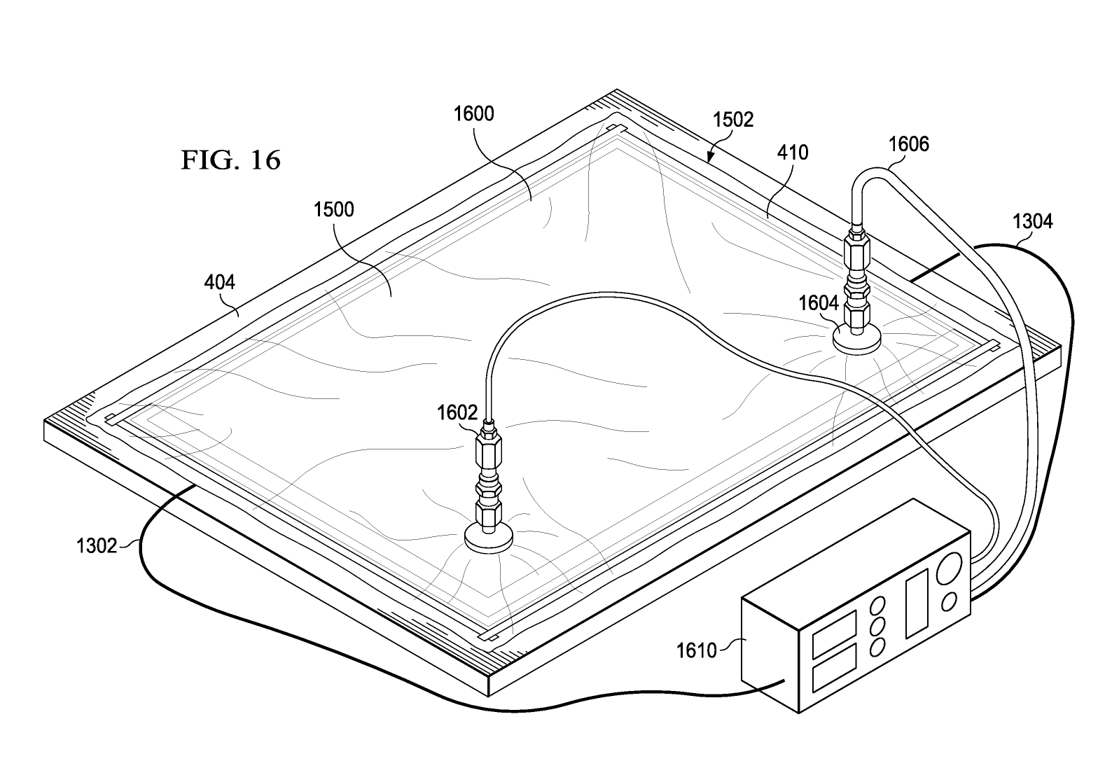

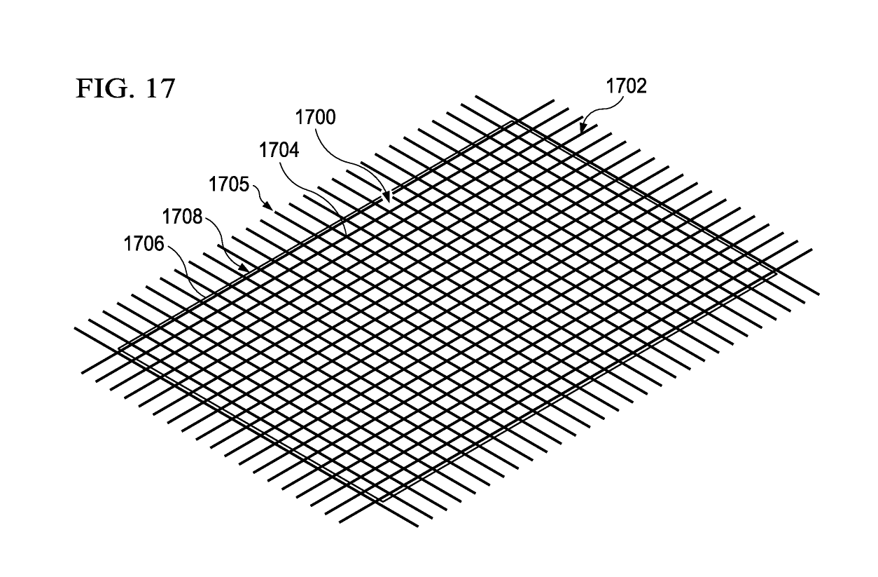

For example, first venting layer 600 in FIG. 6 may take the form of a fiberglass layer instead of positioning fabric 602 in FIG. 6. An example of one implementation of a fiberglass layer may be described in FIG. 17 below. Further, in other illustrative examples, first layer of composite material 500, second layer of composite material 700, and third layer of composite material 900 may take the form of prepreg layers instead of wet layup layer 502, wet layup layer 702, and wet layup layer 902, respectively.

With reference now to FIG. 17, an illustration of a fiberglass layer applied over a layer of composite material is depicted in accordance with an illustrative embodiment. In this illustrative example, fiberglass layer 1700 may be an example of one implementation for a venting layer in number of venting layers 122 in FIG. 1.

As depicted, fiberglass layer 1700 may comprise plurality of fiberglass strands 1702 arranged in cross-hatch pattern 1704. Fiberglass layer 1700 may be applied over composite layer 1706. Further, edges 1705 of fiberglass strands 1702 may extend past edges 1708 of composite layer 1706.

A portion of plurality of fiberglass strands 1702 may extend across the entire length of fiberglass layer 1700, while another portion may extend across the entire width of fiberglass layer 1700. In this manner, each fiberglass strand in plurality of fiberglass strands 1702 may provide a pathway along which a number of fluids (not shown) may travel.

With reference now to FIG. 18, an illustration of a composite layup used in a rework of a part is depicted in accordance with an illustrative embodiment. In this illustrative example, composite layup 1800 may be used to rework portion 1802 of fuselage 1804 of aircraft 1806. In this illustrative example, composite layup 1800 may be an example of one implementation for composite layup 104 in FIG. 1.

As depicted, composite layup 1800 may be laid up on curved surface 1808 of portion 1802 of fuselage 1804. Composite layup 1800 may be cured while composite layup 1800 is laid up over portion 1802 of fuselage 1804. After curing, composite layup 1800 may take the form of a composite patch for fuselage 1804.

Of course, in some illustrative examples, composite layup 1800 may be laid up over a tool and then partially cured to form a partially cured composite layup prior to being placed over portion 1802. This partially cured composite layup may be placed over portion 1802 and then fully cured to form the composite patch for fuselage 1804. In still other illustrative examples, composite layup 1800 may be fully cured to form the composite patch prior to the composite patch being placed over portion 1802 of fuselage 1804.

While composite layup 1800 is described with respect to reworking fuselage 1804, composite layup 1800 or some other suitable composite layup may be used to rework other sections of an aircraft, such as aircraft 1806. For example, without limitation, a composite layup, such as composite layup 104 in FIG. 1, may be used to rework a portion of a wing on an aircraft, a section on a tail of an aircraft, or some other suitable portion or section of an aircraft.

Further, composite layup 104 in FIG. 1 may also be used to rework sections on platforms other than aircraft. For example, without limitation, composite layup 104 may be used to rework a portion of a capsule for a spacecraft, a portion of a wing for a space shuttle, a base for a satellite, and/or some other section for a different type of platform.

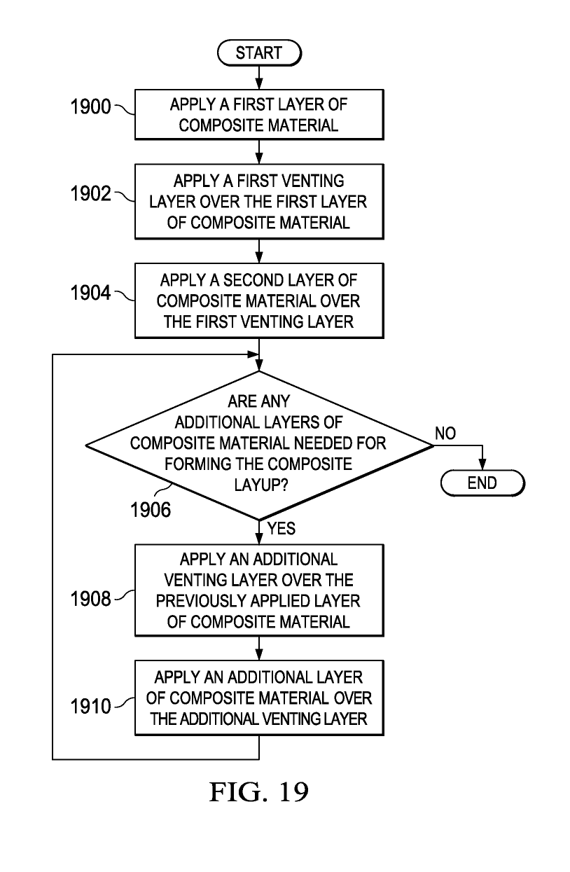

With reference now to FIG. 19, an illustration of a flowchart of a process for reducing porosity in a composite structure is depicted in accordance with an illustrative embodiment. The process illustrated in FIG. 19 may be implemented to reduce porosity 168 in composite structure 102 formed using composite layup 104 in FIG. 1.

The process may begin by applying first layer of composite material 152 (operation 1900). The process may then apply first venting layer 158 over first layer of composite material 152 (operation 1902). Next, the process may apply second layer of composite material 154 over first venting layer 158 (operation 1904).

Thereafter, the process may determine whether any additional layers of composite material are needed for forming composite layup 104 (operation 1906). If additional layers of composite material are not needed for composite layup 104, the process may terminate.

Otherwise, if additional layers of composite material are needed, the process may then apply additional venting layer 162 over previously applied layer of composite material 163 (operation 1908). When additional venting layer 162 is the first additional venting layer to be applied after first venting layer 158, previously applied layer of composite material 163 may be second layer of composite material 154.

Next, the process may apply additional layer of composite material 164 over additional venting layer 162 (operation 1910). The process may then return to operation 1906 as described above. When the process described in FIG. 19 has been completed, composite layup 104 that is formed may be cured. Depending on the implementation, other layers may be applied over composite layup 104 prior to curing.

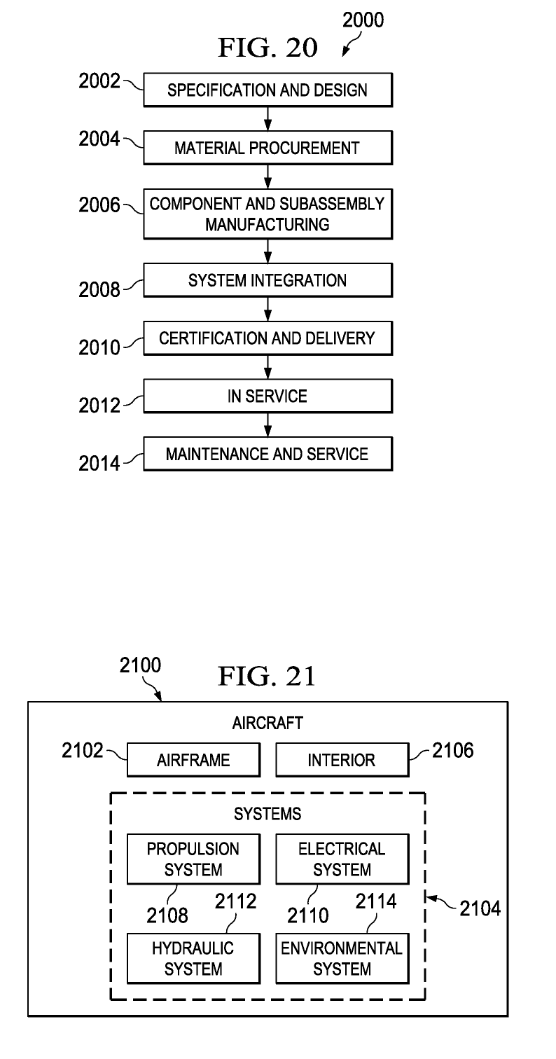

Illustrative embodiments of the present disclosure may be described in the context of aircraft manufacturing and service method 2000 as shown in FIG. 20 and aircraft 2100 as shown in FIG. 21. Turning first to FIG. 20, an illustration of an aircraft manufacturing and service method is depicted in accordance with an illustrative embodiment. During pre-production, aircraft manufacturing and service method 2000 may include specification and design 2002 of aircraft 2100 in FIG. 21 and material procurement 2004.

During production, component and subassembly manufacturing 2006 and system integration 2008 of aircraft 2100 in FIG. 21 may take place. Thereafter, aircraft 2100 may go through certification and delivery 2010 in order to be placed in service 2012. While in service 2012 by a customer, aircraft 2100 may be scheduled for routine maintenance and service 2014, which may include modification, reconfiguration, refurbishment, and other maintenance or service.

Each of the processes of aircraft manufacturing and service method 2000 may be performed or carried out by a system integrator, a third party, and/or an operator. In these examples, the operator may be a customer. For the purposes of this description, a system integrator may include, without limitation, any number of aircraft manufacturers and major-system subcontractors; a third party may include, without limitation, any number of vendors, subcontractors, and suppliers; and an operator may be an airline, a leasing company, a military entity, a service organization, and so on.

With reference now to FIG. 21, an illustration of an aircraft is depicted in which an illustrative embodiment may be implemented. In this example, aircraft 2100 may be produced by aircraft manufacturing and service method 2000 in FIG. 20 and may include airframe 2102 with plurality of systems 2104 and interior 2106. Examples of systems 2104 may include one or more of propulsion system 2108, electrical system 2110, hydraulic system 2112, and environmental system 2114. Any number of other systems may be included.

One or more of devices and parts for any one of systems 2104, including one or more of propulsion system 2108, electrical system 2110, hydraulic system 2112, environmental system 2114, and other systems, may be implemented using a composite structure, such as composite structure 102 formed using composite layup 104 in FIG. 1.

Composite layup 104 and/or composite structure 102 formed using composite layup 104 in FIG. 1 may be formed during one or more of the stages of aircraft manufacturing and service method 2000 in FIG. 20. For example, without limitation, composite layup 104 may be laid up and/or cured to form composite structure 102 in FIG. 1 during material procurement 2004, component and subassembly manufacturing 2006, system integration 2008, routine maintenance and service 2014, and/or other stages in aircraft manufacturing and service method 2000. In some cases, composite layup 104 may be used to rework a structure on aircraft 2100 while aircraft 2100 is in service 2012.

In this manner, one or more apparatus embodiments and/or method embodiments for forming composite structure 102 having reduced porosity 168 in FIG. 1 may be utilized during production stages and/or maintenance stages for an aircraft, such as aircraft 2100 in FIG. 21. The use of a number of the different illustrative embodiments may substantially expedite the assembly of and/or reduce the cost of aircraft 2100. Further, one or more of the different illustrative embodiments may increase a strength and/or durability for aircraft 2100 in FIG. 21.

Although an aerospace example is shown, the different illustrative embodiments may be applied to other industries. These other industries may include, for example, without limitation, the automotive industry, display industry, solar cell industry, semiconductor industry, biomedical device industry, biomedical implant industry, sensor industry, and other suitable industries.

The flowcharts and block diagrams in the different depicted embodiments may illustrate the architecture, functionality, and operation of some possible implementations of apparatuses and methods in an illustrative embodiment. In this regard, each block in the flowcharts or block diagrams may represent a module, segment, function, and/or a portion of an operation or step. For example, one or more of the blocks may be implemented as program code, in hardware, or a combination of the program code and hardware. When implemented in hardware, the hardware may, for example, without limitation, take the form of integrated circuits that are manufactured or configured to perform one or more operations in the flowcharts or block diagrams.

In some alternative implementations of an illustrative embodiment, the function or functions noted in the blocks may occur out of the order noted in the figures. For example, in some cases, two blocks shown in succession may be executed substantially concurrently, or the blocks may sometimes be performed in the reverse order, depending upon the functionality involved. Also, other blocks may be added in addition to the illustrated blocks in a flowchart or block diagram.

Thus, the different illustrative embodiments provide a method and apparatus for reducing porosity in a composite structure. In one illustrative embodiment, a method for reducing porosity in a composite structure may be provided. A venting layer may be applied over a first layer of composite material. A second layer of composite material may be applied over the venting layer. The first layer of composite material, the venting layer, and the second layer of composite material may form a composite layup for the composite structure. The composite layup may be cured to form the composite structure. The venting layer may provide a number of pathways for allowing a number of fluids to escape out of the composite layup during curing of the composite layup.

The description of the different illustrative embodiments has been presented for purposes of illustration and description and is not intended to be exhaustive or limited to the embodiments in the form disclosed. Many modifications and variations may be apparent to those of ordinary skill in the art. Further, different illustrative embodiments may provide different features as compared to other illustrative embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. A method for reducing porosity in a composite structure, the method comprising:
applying a first layer of composite material over a surface;
applying a venting layer over the first layer of composite material; and
applying a second layer of composite material over the venting layer in which the first layer of composite material, the venting layer, and the second layer of composite material form a composite layup for the composite structure.

2. The method of claim 1 further comprising:
applying an additional venting layer over a previously applied layer of composite material;
applying an additional layer of composite material over the additional venting layer; and
repeating the steps of applying the additional venting layer over the previously applied layer of composite material and applying the additional layer of composite material over the additional venting layer until a selected number of layers of composite material have been laid up to form the composite layup.

3. The method of claim 1, wherein the venting layer is a first venting layer and further comprising:
applying a second venting layer over the second layer of composite material; and
applying a third layer of composite material over the second venting layer in which the first layer of composite material, the first venting layer, the second layer of composite material, the second venting layer, and the third layer of composite material form the composite layup for the composite structure and in which the first venting layer and the second venting layer are configured to reduce the porosity of the composite structure.

4. The method of claim 1, wherein the venting layer provides a number of pathways for allowing a number of fluids to escape out of the composite layup during curing of the composite layup.

5. The method of claim 4, wherein edges of the venting layer extend past first edges of the first layer of composite material and second edges of the second layer of composite material and wherein a pathway in the number of pathways extends from one edge of the edges of the venting layer to another edge of the edges of the venting layer to allow the number of fluids to escape out of the composite layup during curing of the composite layup.

6. The method of claim 4, wherein the number of fluids includes at least one of air, moisture, a chemical, and a volatile gas.

7. The method of claim 1 further comprising:
curing the composite layup to form the composite structure, wherein a number of fluids escapes through a number of pathways formed by the venting layer during curing of the composite layup such that the porosity in the composite structure is reduced.

8. The method of claim 1, wherein the step of curing the composite layup to form the composite structure comprises:
applying at least one of heat and pressure to the composite layup to form the composite structure.

9. The method of claim 1 further comprising:
pre-curing the composite layup to form the composite structure, wherein the composite structure is a composite patch; and
applying the composite patch to a rework location at a later point in time.

10. The method of claim 1 further comprising:
curing partially the composite layup to form a partially cured composite layup;
placing the partially cured composite layup at a rework location; and
curing fully the partially cured composite layup to form the composite structure, wherein the composite structure is a composite patch.

11. The method of claim 1, wherein applying the first layer of composite material over the surface comprises:
applying the first layer of composite material over the surface of a location at which an inconsistency is present, wherein the composite structure is a composite patch for the inconsistency.

12. The method of claim 1, wherein each of the first layer of composite material and the second layer of composite material comprises a number of plies.

13. The method of claim 1, wherein the first layer of composite material and the second layer of composite material are selected from at least one of a wet layup layer and a prepreg layer and wherein the venting layer is selected from one of a positioning fabric, Buckypaper, a fiberglass layer, and a nanomaterial layer.

14. The method of claim 1, wherein the surface is selected from one of a tool, a caul plate, a mandrel, a wing, a fuselage, a spar, a support structure, a skin panel, and a spacecraft.

15. A method for forming a composite patch, the method comprising:
applying a first layer of composite material over a surface;
applying a first venting layer over the first layer of composite material;
applying a second layer of composite material over the first venting layer;
applying a second venting layer over the second layer of composite material in which the first venting layer and the second venting layer are selected from one of a positioning fabric, Buckypaper, a fiberglass layer, and a nanomaterial layer;
applying a third layer of composite material over the second venting layer in which the first layer of composite material, the first venting layer, the second layer of composite material, the second venting layer, and the third layer of composite material form a composite layup for the composite patch and in which each of the first layer of composite material, the second layer of composite material, and the third layer of composite material comprises a number of plies and is selected from at least one of a wet layup layer and a prepreg layer; and
curing the composite layup to form the composite patch in which a number of fluids escapes through a number of pathways, formed by the first venting layer and the second venting layer, during curing of the composite layup such that porosity in the composite patch is reduced and in which the number of fluids includes at least one of air, moisture, a chemical, and a volatile gas.

16. An apparatus comprising:
a plurality of layers of composite material; and
a number of venting layers laid up between the plurality of layers of composite material in which the number of venting layers and the plurality of layers of composite material form a composite layup and in which the number of venting layers is configured to provide a number of pathways for allowing a number of fluids to escape out of the composite layup during curing of the composite layup.

17. The apparatus of claim 16, wherein the plurality of layers of composite material include a first layer of composite material and a second layer of composite material and the number of venting layers includes a first venting layer in which the first venting layer is laid up between the first layer of composite material and the second layer of composite material.

18. The apparatus of claim 17, wherein the plurality of layers of composite material further include a third layer of composite material and the number of venting layers further includes a second venting layer in which the second venting layer is laid up between the second layer of composite material and the third layer of composite material.

19. The apparatus of claim 17, wherein edges of the first venting layer extend past first edges of the first layer of composite material and second edges of the second layer of composite material and wherein a pathway in the number of pathways extends from one edge of the edges of the first venting layer to another edge of the edges of the first venting layer to allow the number of fluids to escape out of the composite layup during curing.

20. The apparatus of claim 16, wherein the number of fluids includes at least one of air, moisture, a chemical, and a volatile gas.

21. The apparatus of claim 16 further comprising:
a curing system configured to cure the composite layup to form a composite structure, wherein the number of fluids escapes through the number of pathways formed by the number of venting layers during curing of the composite layup such that porosity of the composite structure is reduced.

22. The apparatus of claim 21, wherein the composite layup is laid up at a rework location and wherein the curing system is further configured to cure the composite layup at the rework location to form a composite patch.

23. The apparatus of claim 21, wherein the curing system is further configured to partially cure the composite layup to form a partially cured composite layup that is placed at a rework location and wherein the curing system is further configured to fully cure the partially cured composite layup at the rework location of the inconsistency to form a composite patch for the inconsistency.

24. The apparatus of claim 21, wherein the curing system is configured to pre-cure the composite layup to form a composite patch and wherein the composite patch is applied to a rework location at a later point in time.

25. The apparatus of claim 16, wherein a first layer of composite material in the plurality of layers of composite material is laid up over a surface in which the surface is selected from one of a tool, a caul plate, a mandrel, a wing, a fuselage, a support structure, a skin panel, and a spacecraft.

26. The apparatus of claim 16, wherein each of the plurality of layers of composite material comprises a number of plies.

27. The apparatus of claim 16, wherein a layer of composite material in the plurality of layers of composite material is selected from one of a wet layup layer and a prepreg layer and wherein a venting layer in the number of venting layers is selected from one of a positioning fabric, Buckypaper, a fiberglass layer, and a nanomaterial layer.

28. A composite patch comprising:
a first layer of composite material applied over a surface;
a first venting layer applied over the first layer of composite material;
a second layer of composite material applied over the first venting layer;
a second venting layer applied over the second layer of composite material in which the first venting layer and the second venting layer are selected from one of a positioning fabric, Buckypaper, a fiberglass layer, and a nanomaterial layer; and
a third layer of composite material applied over the second venting layer in which each of the first layer of composite material, the second layer of composite material, and the third layer of composite material comprises a number of plies and is selected from one of a wet layup layer and a prepreg layer; in which the first layer of composite material, the first venting layer, the second layer of composite material, the second venting layer, and the third layer of composite material form a composite layup configured to be cured to form the composite patch; in which the first venting layer and the second venting layer are configured to provide a number of pathways for allowing a number of fluids to escape out of the composite layup during curing of the composite layup such that porosity of the composite patch is reduced; and in which the number of fluids includes at least one of air, moisture, a chemical, and a volatile gas.
